(19) United States
(12) Patent Application Publication
(10) Pub. No.: US 2006/0129438 A1
(43) Pub. Date: Jun. 15, 2006

(54) Method, system, and computer readable medium for dynamically generating multi-modal trip choices

(75) Inventor: Michael A. Robinson, Carrollton, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Sabre Inc.

(21) Appl. No.: 11/009,609

(22) Filed: Dec. 10, 2004

(51) Int. Cl. G01C 21/34; G01C 21/36

(52) U.S. Cl. 705/6

(57) ABSTRACT

A method, system, and computer-readable medium for generating travel options along a route are provided. The method includes identifying a plurality of conveyances with each having associated booking information in response to a request for travel. The method also includes generating a trip value table in response to the request, wherein the trip value table includes booking information and historical information for comparable conveyances. The method further includes outputting the conveyances, associated booking information, and trip value table.

### BACKGROUND OF THE INVENTION

1) Field of the Invention

The present invention relates to multi-modal trip choices and, more particularly, to a system, method, and computer readable medium for providing real-time booking information for multiple modes of transportation in a combined innovative method.

2) Description of Related Art

Many techniques have been developed that provide travelers with the capability to customize an itinerary. For instance, U.S. Pat. No. 5,948,040 to DeLorme et al. discloses a travel reservation information and planning system (TRIPS). A user is able to obtain a customized travel route and plan based upon answers to the questions WHERE?, WHAT?, WHEN?, and HOW?. DeLorme discloses a TRIPS that is capable of determining, reserving, and/or ticketing locations along a travel route between a user-selected travel origin and travel destination, including a user-selected waypoint and points of interest (POI) along the way, such as geographic places, areas or regions, latitude/longitude, street address, etc. In addition, a set of electronic maps may be presented to the user for review, where the maps may be manipulated and queried by the user. The TRIPS is also able to obtain information regarding events of interest (EOI) (e.g., theatre performance) for which multimedia information is available for presenting in a travelog. The travelog may be generated and customized for the user-defined travel route including both multimedia information on the type of transportation, transportation routes, waypoints, and POIs selected by the user, and actual reservation information on availability, arrival/departure times, pricing, etc. Users may engage in an iterative planning process that may include revising or editing travel plans, previewing travelogs of alternative routes, selecting POI parameters, and comparing times and cost of transportation options, in order to achieve a satisfactory travel plan. Users may print text itinerary, travel maps, information on points of interest, reservation confirmations, or discount coupons.

It is common to provide information regarding multiple modes of travel, such as rail and flight, concurrently to a traveler inquiring about a route. This is commonly done using brochures, advertisements, and combinations of other travel information which is collated and assembled by the traveler or service provider. Having multiple options to choose from provides the user with different options not only for the mode of travel, but also the price and route of travel. For instance, a traveler may wish to travel by flight on a departing leg of a route but return by train such that the total price of travel may be less than if a roundtrip flight were purchased. In this regard, the traveler is presented with alternative modes of travel that allow the traveler to customize a particular trip.

As a result of providing the traveler with an integrated vehicle for multiple modes of travel from which to choose, sellers, suppliers, and service providers are capable of generating revenue streams by not only selling additional conveyances, but also through merchandizing with advertisements, screen position, and optional selections. In addition, presenting multiple modes of travel along with associated prices increases the likelihood that a traveler will make a reservation. In other words, a traveler presented with more than one travel option typically results in a higher session-to-book conversion than if only one option was given.

However, travelers presented with different modes of travel and prices may lack the confidence to immediately book a reservation. For example, a traveler may believe that a better deal may come along at a later date and delay booking a reservation. By delaying, the traveler may potentially be forced to pay a higher price at a later date, and/or the itinerary may no longer be available.

It would therefore be advantageous to provide a method and system that is capable of generating multiple modes of travel along a requested route. It would further be advantageous to provide for a method and system that is capable of increasing consumer confidence in booking travel. It would also be advantageous to provide a method and system that is capable of conveniently presenting an integrated set of travel options to a traveler.

### BRIEF SUMMARY OF THE INVENTION

The invention addresses the above needs and achieves other advantages by providing a method for generating travel options along a route, as well as an associated system and computer-readable medium. The method includes identifying information regarding a plurality of modes of travel for a requested travel route such that the traveler is provided the opportunity to create a customized itinerary. Because the user is presented with multiple travel options, the probability of a higher session-to-book conversion increases. In addition, the method includes generating a trip value table that typically includes historical booking information. The trip value table increases the traveler's confidence in making a decision to book the reservation, as the traveler is capable of seeing previous booking information for the same or similar travel route.

In one embodiment of the present invention, a method for generating travel options along a route is provided. The method includes identifying a plurality of conveyances with each having associated booking information in response to a request for travel. The conveyances and associated booking information may be identified in real time. The method also includes generating a trip value table in response to the request. The trip value table includes booking information and historical information for comparable conveyances, such as a list of lowest prices. The method further includes outputting the conveyances, associated booking information, and trip value table.

In various aspects of the method, the method includes receiving the request for travel having price, origin, destination, dates, number of travelers, points of interest, travel preferences, preferred route, and/or amenities. A conveyance typically includes a bus trip, train trip, cruise, automobile rental, flight, and hotel stay. The associated booking information may include price, availability, vendor, origin, destination, and/or dates of the request for travel. Similarly, the booking information included in the trip value table may include price, type of conveyance, vendor, year, dates, and/or length of stay for the request for travel.

In further aspects of the present invention, the method includes identifying the conveyances proximate to an anchor and/or along a corridor. The method could also include identifying a sequence of conveyances along a proposed travel route, where the sequence may include two or more different types of conveyances. In addition, the method may include identifying a plurality of proposed travel routes. The method is also capable of identifying an upsell opportunity based on the conveyances, associated booking information, and trip value table, wherein the upsell increases a price of at least one conveyance based on comparable prices for other conveyances. The conveyances, associated booking information, and trip value table may be displayed on an interactive map, and the trip value table may be periodically updated.

The foregoing method may be implemented by the execution of instructions stored by a computer-readable medium that cause a computing device to perform as described. Moreover, the invention may also be embodied in a system for generating travel options along a route. The system includes at least one processing element for identifying a plurality of conveyances with each having associated booking information in response to a user request, generating a trip value table having booking information and historical information for comparable conveyances in response to the request, and outputting the conveyances, associated booking information, and trip value table. The system could also include a client device for inputting a request for travel, as well as a storage element for storing the historical booking information.

The present invention therefore provides a method, system, and computer-readable medium that are capable of dynamically generating real-time conveyances around travel anchors or along travel route corridors. The trip value tables list historical booking information that provides a price value index to the consumer, which may be used by the consumer to pre-price their travel choices, as well as to provide historical comparisons with other seasons, years, or options. Therefore, the traveler is provided with not only current availability and pricing information, but also historical booking information, such that the traveler may make a reservation with an increased level of confidence.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a pictorial diagram illustrating a client-server network, according to one embodiment of the present invention;

FIG. 2 is a block diagram illustrating a system for generating travel options along a route, according to one embodiment of the present invention;

FIG. 3 is a pictorial diagram of a map illustrating multiple modes of travel and associated pricing information for a given route between anchors, according to one embodiment of the present invention;

FIG. 4 is a pictorial diagram of a map illustrating multiple modes of travel and associated pricing information for a given route, according to one embodiment of the present invention;

FIG. 5 is an enlarged pictorial diagram of the route shown in FIG. 4; and

FIG. 6 is a table illustrating a trip value table, according to one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

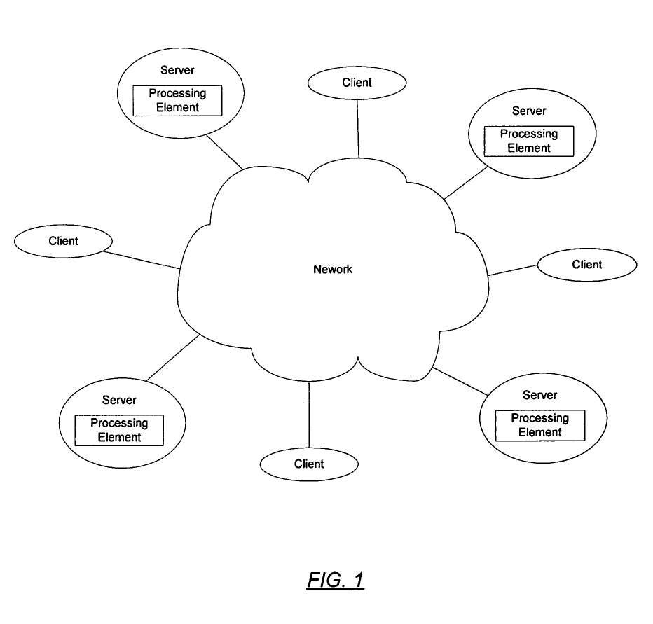

Referring now to the drawings and, in particular to FIG. 1, there is shown a system for communicating through a network. The system generally includes a client-server system interconnected through a network. The system is applicable to any number of travel industries, such as airline, hotel, automobile, cruise, bus, or rail. Therefore, the system is not limited to any one travel industry and, as will be discussed below, may include a combination of any number of travel industries.

As referred to herein, the terms “client” and “server” are generally used to refer to a computer's role as a requester of data (i.e., the client) and a provider of data (i.e., the server). The client and server may communicate via a communication network, such as the Internet, an intranet, an extranet, or any other suitable network. As also used herein, the term “client” corresponds to any suitable computing device, typically a computer, a personal data assistant, mobile phone, or the like, capable of communicating with a server. Likewise, the server is generally comprised of a processing element such as a computing device having at least one or more processors and associated memory device(s) as known to those skilled in the art. Moreover, the server may be maintained or otherwise operated by a service provider. The client and server may comprise any number of conventional components but typically include a bus, central processing unit (CPU), read-only memory (ROM), random access memory (RAM), storage device, input/output controller, and network interface, and may operate at least partially under the control of one or more software programs or other applications, as all known to those skilled in the art. Any number of clients and servers may be included in the system and in communication with one another.

In a web environment, web browsers reside in clients, and specially formatted “web documents” reside on and/or are constructed by web servers. In operation, a browser opens a connection to a server and initiates a request for a document. Typical examples of “browsers” include Netscape Navigator® by Netscape Corportion, Internet Explorer® by Microsoft Corporation, and Opera® by Opera Software A/S. The server delivers the requested document, typically in the form dictated by a standard such as the “HyperText Markup Language” (HTML) format. After the document is delivered, the connection is closed. The browser displays the document or performs a function designated by the document.

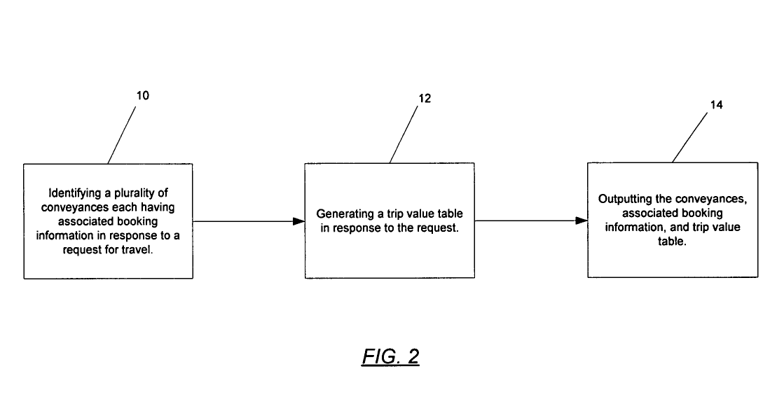

FIG. 2 depicts a method of generating travel options along a route. The method generally includes identifying a plurality of conveyances each having associated booking information in response to a request for travel (block 10). The method also includes generating a trip value table in response to the request (block 12) and outputting the conveyances, associated booking information, and trip value table (block 14). As used herein, the term “conveyance” is not meant to be limiting and includes various modes of travel, such as bus, rail, cruise, automobile, airline, and hotel. In addition, the term “booking information” is not meant to be limiting and includes any information associated with booking a reservation, such as price, availability, origin and destination, vendor, and dates of travel. Thus, booking information typically relates to information requested by a traveler and/or information that may affect the traveler's decision to book the conveyance(s) after inputting a request for travel.

A traveler typically inputs a request for travel, such as with a client device, that is received by a processing element, such as a server. The request may include a variety of information, such as price, origin, destination, dates, number of travelers, points of interest, travel preferences, preferred route, and/or amenities. As also used herein, the origin and destination locations for each conveyance, as well as intermediate locations between the origin and destination are generally defined as “anchors.” In the foregoing exemplary request, the anchors could be an origin or destination city, as well as points of interest located between the origin and destination. Additionally, the path between a pair anchors is termed a “corridor.” As such, a conveyance could be identified proximate to an anchor and/or along the corridor. In addition, as used herein, the conveyance is identified proximate to an anchor, such that the conveyance is not limited to being identified at an anchor, as the conveyance could be located near the anchor or within a predefined distance from the anchor. A combination of anchors and corridors may form a travel route that may be specifically requested by a traveler or suggested by the processing element.

In the above request, points of interest may include, for example, shore excursions, local tours, monuments, additional anchors, other locations along corridors, or locations proximate to requested anchors. Travel preferences generally relate to features a traveler would prefer but does not necessarily require for satisfying a request. Thus, travel preferences associated with airline travel could include, for example, non-stop travel, minimum connect time, number of connections, or seat class. In addition, amenities could include any number of features offered by a particular conveyance. For instance, with respect to hotels, the amenities could include maximum room occupancy, pets, pool, continental breakfast, or any other feature of a particular hotel.

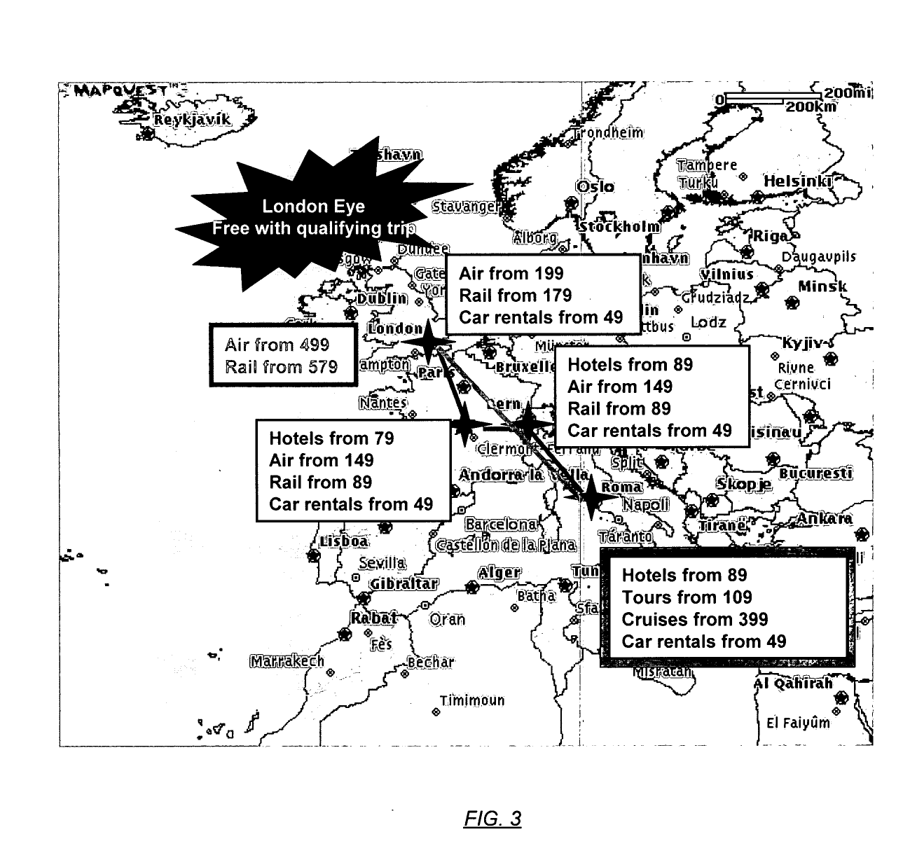

In one embodiment of the present invention, the processing element identifies a plurality of conveyances satisfying the traveler's request. The resulting conveyances may be presented in various manners. In one embodiment, as shown in FIG. 3, a map may be created displaying conveyances proximate to each anchor along the travel route. In this process, the processing element is also capable of identifying proposed conveyances and associated booking information using all viable alternatives satisfying the traveler's request at or near anchors, along corridors, and/or at or near points of interest, to create a proposed travel route or itinerary. FIG. 3 demonstrates that the processing element may identify air, rail, car, and/or cruise ship conveyances proximate to each anchor. While the anchors and the corresponding conveyances may be represented in different manners, the processing element of one embodiment generates a map as shown in FIG. 3 in which anchors are shown as stars and information, such as lowest fares, for the conveyances is shown in a rectangular inset. Each conveyance may include an associated price that is displayed to the traveler, such that the traveler may readily determine the lowest priced conveyance or customize a travel route with multiple conveyances. For instance, the traveler may decide that it would be more economical to fly between London and Rome, but then to drive the remaining corridors of the travel route. Furthermore, the map shown in FIG. 3 illustrates that the processing element may provide, and the client device may display, advertisements along with the conveyances and booking information, such as a free voucher for the London Eye with a qualifying trip.

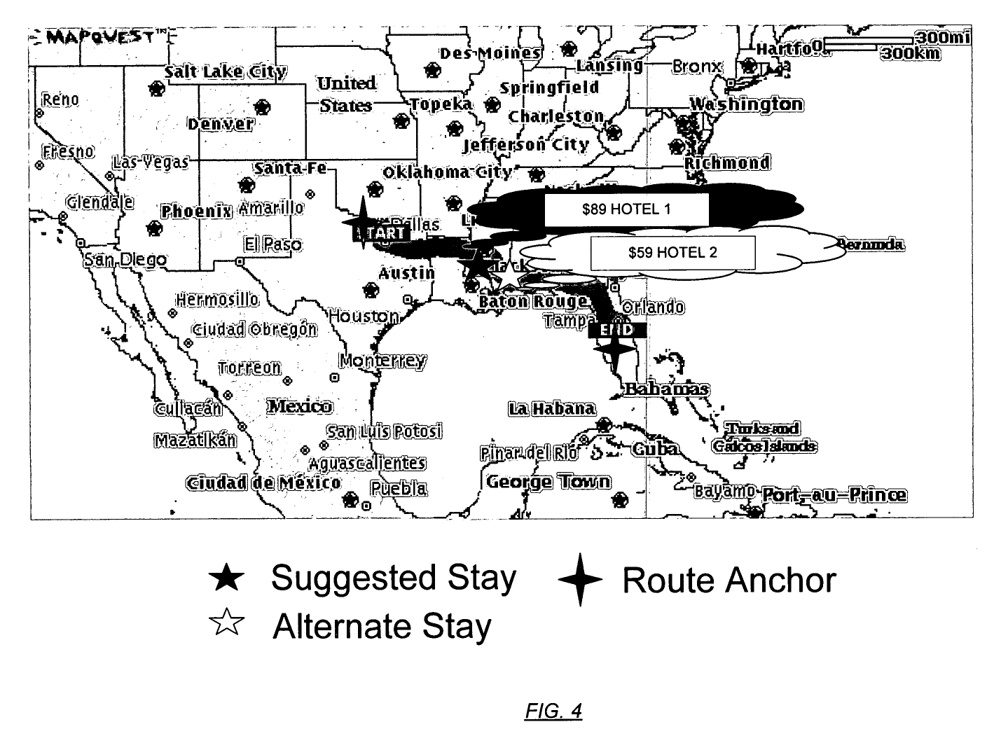

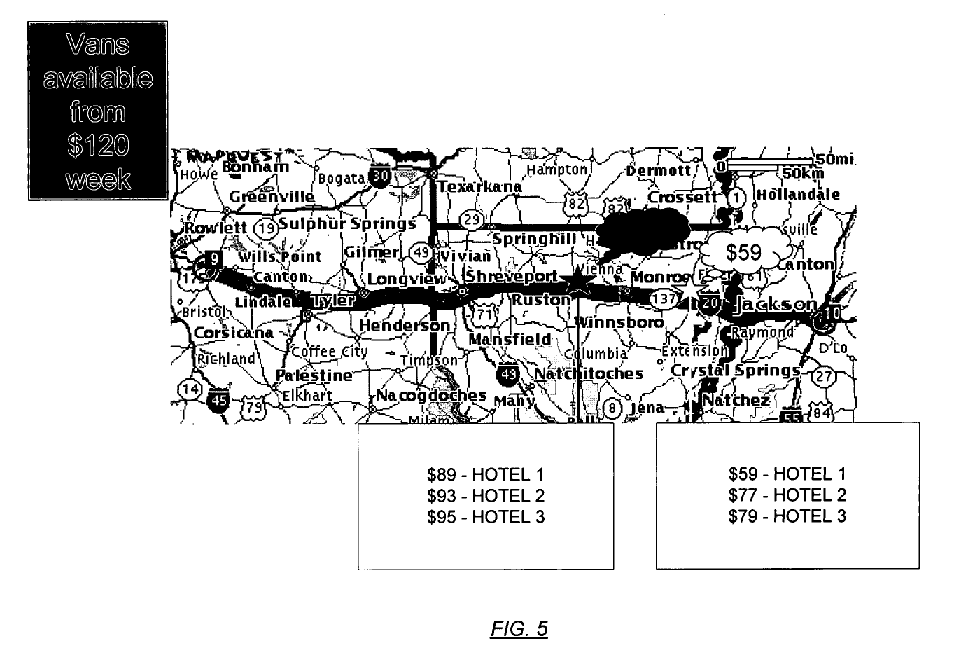

FIG. 4 depicts another map that may be generated by the processing element having suggested and alternative hotels located along a corridor. The conveyances are typically identified based on a predefined distance from each anchor or along a corridor, as well as the price and booking reference information for each conveyance. Thus, Hotel 1 at $89 is the suggested hotel, while Hotel 2 at $59 is the alternative hotel given. A zoomed map that may also be generated by the processing element is shown in FIG. 5 that provides greater detail of the corridor and conveyances. The map illustrates three hotel choices for each location along the corridor, although any number could be provided. Consequently, the traveler is capable of choosing a particular hotel based not only on price but also on location. In the map shown in FIG. 5, a traveler may be more willing to travel further east on I-20 past Vienna to save money on hotel accommodations. Moreover, the provider is capable of generating revenue by selling more conveyance options through advertising by providing alternative conveyances, such as that shown by the advertisement for vans from $120 a week. As such, a traveler may find renting the van for $120 a week is more economical or convenient when compared to other conveyances.

The processing element takes into account various inputs from the travel request, such as origin and destination, and may access a computerized reservation system (CRS) for an airline, a car rental database for cars, a cruise database for cruises, and return information based on some preselected criteria such as lowest price, closest to a desired time of departure or arrival, etc. to provide booking information. The processing element may also determine where a traveler is likely to stay based on the travel request and then identify potential hotels from a hotel database. Thus, the processing element may access various databases and resources to determine booking information associated with the conveyances determined as a result of the travel request. Bookings will be done by selecting the corridor or desired travel conveyances which will then invoke a booking screen to continue the reservation process.

Therefore, the service provider is capable of presenting conveyances that not only satisfy the traveler's request, but also suggest conveyances that satisfy at least a portion of the traveler's request but that may be more attractive in some other regard. For example, the conveyances could include alternative dates of travel, anchors in close proximity to the requested origin and destination, or optional travel preferences or amenities. Thus, the processing element is capable of identifying alternative conveyances and then proceeding in the same manner as of the original conveyances to generate booking information.

In addition, suppliers and service providers may enter agreements that allow for suggested or optional conveyances to be presented to the traveler. In one embodiment of the present invention, a seller capable of satisfying a travel request may have an agreement with other sellers or suppliers that offer alternative conveyances or advertisements. For example, an airline supplier may have an agreement with a hotel supplier, such that hotels proximate to a selected origin and destination may be identified and offered with a flight that was originally requested.

Furthermore, points of interest may be generated based on the conveyances satisfying the traveler's request such that specified criteria included within the travel request or conveyances creates various points of interest. For example, a traveler requesting a point of interest relating to a specific museum may also cause the processing element to determine additional museums proximate to an anchor or along a corridor. Similarly, advertisements may be generated in response to particular conveyances or specified criteria. For instance, entering a request for travel for a location proximate to an anchor may trigger the processing element to generate a pop-up or banner advertisement for points of interest also proximate to the anchor. In addition, driving distance may be used to determine conveyances in predefined areas proximate to anchors or corridors. Driving distance may be used to determine not only conveyances, but also reservable features and attractions along a corridor, such as for hotels.

Also, various factors may be considered prior to displaying the trip value table and conveyances, such as factors that are particular to a traveler. For instance, a currency converter could be employed to generate prices for the conveyances and trip value tables that are understandable by the traveler.

Conveyances may also include mechanisms for generating an upsell for a particular conveyance. In other words, if a supplier is “overcompetitive” (i.e., effective price levels are too low) on a given market and date, the supplier will determine that the expected value of sales in that market and date would be increased by raising the price. One approach to fare upsell is to dynamically apply an increase to the price amount on the conveyance involved on that market and date. Various techniques have been developed for generating the upsell. With respect to the airline industry, the availability of the lower fare can be closed (i.e., made unavailable) thus raising the effective price (for the specific itinerary involved) to a different fare filed in the next higher class. Another common situation involves a supplier being “undercompetitive” in that the price levels are higher than the competition and may be remedied by reducing the effective fare amount by opening up a previously closed class, if possible. A further example within the scope of the present invention involves modifying the price. For instance, if a direct flight between anchors is $100, and the current offering for rail between the same anchors is $50, the seller or supplier may wish to upsell the rail price to $80 to realize a $30 increase in revenue. The processing element will store and maintain both the original rate as well as the upsell for revenue sharing and supplier value analysis. In addition, the processing element is capable of dynamically carrying out the upsell using a rule based decision database so that it may store and compute both original rate and upsell.

The processing element will also be capable of determining alternative amenities based on the type of conveyance identified or selected. For instance, RV and van conveyances may be used to determine potentially reservable add on components such as DVD players and game systems. RV conveyances could also be used to create additional request/search parameters for extended parking, external water, and external RV cleanouts. Requests for car rentals may connect directly via high speed lines to reservation systems and appropriate car rental providers to get reservable vehicles. Car rental options, such as per-day or per-mile rate plans, may be compared to determine the better value to the consumer. Non-reservable components, such as DVD players and game systems, may also be presented as choice alternatives.

The number of travelers may be used by the processing element to determine the type of conveyance presented to the traveler. For example, the number of travelers may be used to determine the size of the conveyance (e.g., car versus van), as well as hotel stay options and suggestions. With respect to hotels, restrictions relating to the maximum number in a room can be enforced in advance, and adjoining room options can be presented to automatically determine the most appropriate options for the traveler. The size of each traveler group, as well as the presence of multiple traveler groups within the same vehicle, will automatically trigger certain vehicle preferences such as three row sets, zoned speaker options, and game systems and DVD choices. Moreover, with respect to automobile rentals, the desired daily driving distance may be used to determine recommended stay areas as well as reservable or free features/attractions along the drive route. A list of hotels with real-time availability and rates may be presented within an area determined by the processing element computed by adding desired driving distance to origin.

Furthermore, the traveler may solicit a particular vendor in the travel request. For instance, a hotel chain and rate preferences may be used to tailor the response to the travel request to designate types of properties as well as desired rate ranges and payment options that comply with the request. A full list of hotel property amenities, room amenities, and rate amenities may be supported with the addition of unique drive path attributes such as, extended parking for RV/trailers, external water for RV, and external RV Cleanouts. In addition, the traveler may be provided the size, weight, and number of animals in a room along with applicable pet deposit requirements for a specified vendor.

The map display shown in FIGS. 3-5 is generated by MapQuest.com, Inc. based on parameters defined by the processing element and overlaid with information identifying anchors and corridors and providing booking information, although any suitable interactive map display may be incorporated with the present invention. In addition, the present invention is applicable to not only domestic travel but also international travel. Each of the anchors, corridors, and points of interest are typically geocoded (i.e., include a latitude and longitude) by the processing element such that each may be readily plotted on a map display. The map typically includes user-friendly and descriptive icons, labels, advertisements, and the like that may be displayed on the map. Moreover, the map display is preferably interactive such that the traveler may select an anchor, corridor, or other location on the map that generates additional options or searches, or modifies the display. For instance, as shown in FIGS. 4 and 5, the traveler could zoom in on a portion of the map to display further detail of the travel route. In a further example, a traveler selecting a particular conveyance may generate an advertisement to be displayed, where the advertisement includes additional conveyance options.

In one embodiment, the traveler may select a conveyance, and the traveler is immediately directed to a webpage or pop-up display for booking the reservation. Navigation and booking prompts will be prominent on the display to guide and assist the traveler. As such, the conveyances generally include availability information such that a conveyance that is displayed is also available. Therefore, the traveler is not required to perform additional searching once the conveyances and associated booking information is generated. Furthermore, the traveler could incrementally build an itinerary or may select a package that satisfies the traveler's request. As such, the traveler may build a route-by-route itinerary, as well as an origin and destination itinerary. To decrease the possibility of “bait and switch,” the lowest cost of a conveyance for a particular anchor or corridor from a previous screen may be included on subsequent screens. In other words, providing the lowest cost conveyance on each screen minimizes the risk that a traveler will be lured into selecting a higher priced conveyance or simply forget the previously displayed prices and/or conveyance options.

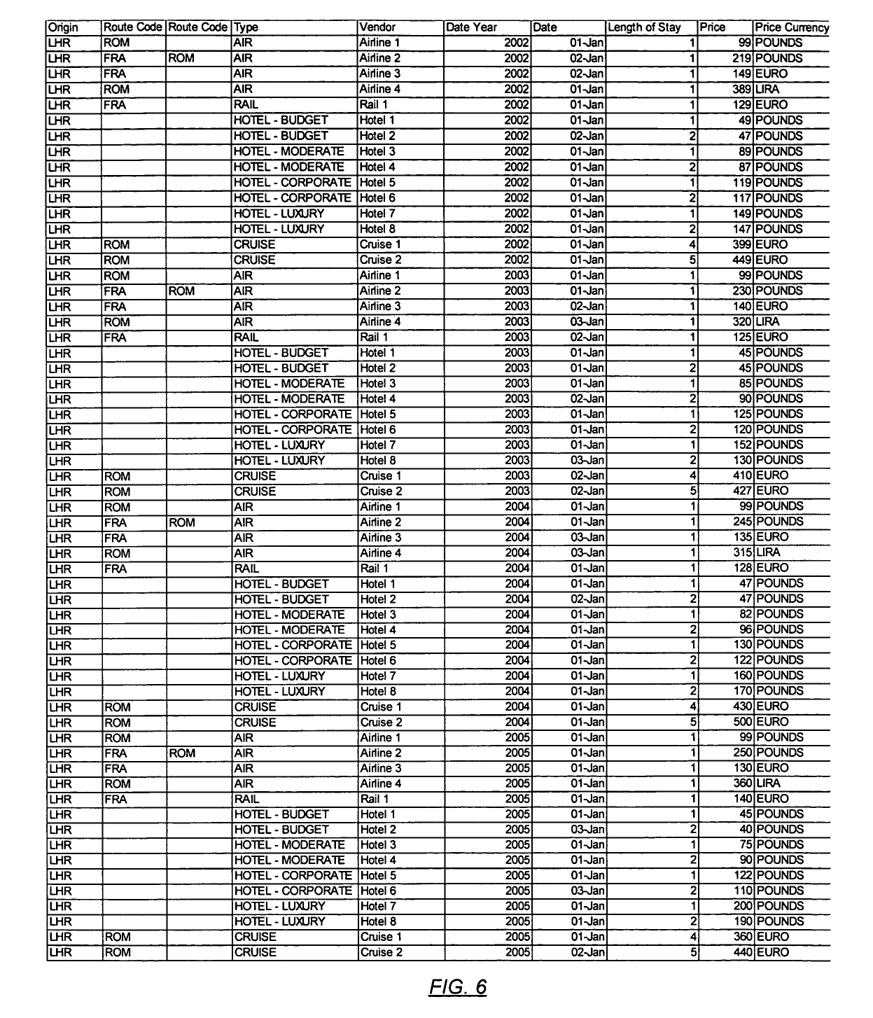

FIG. 6 illustrates an exemplary trip value table that may be constructed by the processing element according to one embodiment of the present invention. The trip value table includes booking information that may be displayed prior to the traveler inputting a request for travel, displayed concurrently with the conveyances (e.g., concurrent with the map), or displayed after the conveyances have been generated to allow the traveler to compare similar travel requests. In this regard, the trip value table typically includes historical booking information (i.e., booking information for previous conveyances) such that the traveler may readily make comparisons between current and historical booking information. Thus, the trip value table may include historical booking information based on a particular season, year, travel preferences, or amenities. Accordingly, the trip value table is presented to the traveler to provide the traveler a value index that may be used by the traveler to pre-price their itinerary prior to making a decision as to book a reservation. The trip value table may be displayed on the interactive map along with the conveyances. The trip value table would typically be generated by the processing element, where the processing element could access a database or similar storage element to extract the relevant booking information for the trip value table including both current and historical information.

As shown in FIG. 6, the trip value table may include an origin, route codes detailing through and/or destination cities, type of conveyance, vendor, year, dates, length of stay, and price. Therefore, a traveler wishing to take a New Year's Day trip from London (LHR) to Rome (ROM) or Frankfurt (FRA) may find prices for various conveyances for the same or similar dates for previous years, as well as current prices for the actual dates of travel. A traveler wishing to fly from LHR to ROM will find that for 2002, 2003, and 2004, the price for Airline 1 has consistently been 99 pounds. As such, the traveler will gain additional confidence that a quoted price of 99 pounds for Airline 1 in 2005 would most likely not fall any lower and need not wait prior to booking a reservation. Thus, the traveler may use historical information to gauge the probability that the price of a conveyance will increase, decrease, or stay the same.

The historical booking information contained in the trip value table is typically the lowest prices available for the same or similar travel requests. Thus, for air travel, the actual lowest sold rate per segment category will be displayed, where the categories may include, for example, scheduled, low-cost, non-stop, or commuter options, irregardless of the vendor or supplier. Thus, the booking information may be filtered to generate the lowest prices without restricting a particular conveyance from being generated or displayed to the traveler. With respect to the rail, the categories could be distinguished by scheduled stops, while hotels may include categories for the type of hotel and length of stay. Moreover, cruises may be distinguished by the length of the cruise and scheduled stops.

The trip value table presented in FIG. 6 is not meant to be limiting, as any number of trip value tables may be generated, where each trip value table may include various forms of booking information. For instance, a separate trip value table could be generated for each conveyance or anchor. In addition, the booking information may be generated and presented in the trip value table based on any number of predetermined criteria or criteria defined by the traveler and/or the system. As such, the traveler may search for particular historical information to include within the trip value table. For example, the traveler could request the lowest airfares for the past two years for the same or similar travel requests. Furthermore, the trip value table may include only a portion of a trip value table such as that shown in FIG. 6, such that only airfare for a particular origin, destination, and dates of travel, and may be presented or otherwise displayed for the traveler. In this regard, although described as a table, the trip value table is not limited to any tabular arrangement and may be configured in any suitable manner. The trip value tables could be updated periodically (e.g., daily, weekly, month, or yearly) to increase the accuracy and effectiveness of the historical information. Additionally, the trip value table may include current booking information (i.e., current booking information for travel in the future) such that the traveler may readily compare historical and current booking information for each conveyance, such as that shown in FIG. 6 (i.e., booking information for 2005 being current). This option would be beneficial in those instances where the trip value table and conveyances are generated together and not independently of one another.

According to one aspect of the present invention, the system generally operates under control of a computer program product. The computer program product for performing the methods of embodiments of the present invention includes a computer-readable storage medium, such as the memory device associated with a processing element, and computer-readable program code portions, such as a series of computer instructions, embodied in the computer-readable storage medium. In this regard, FIG. 2 is control flow diagram of a method and program product according to the invention. It will be understood that each block or step of the control flow diagram, and combinations of blocks in the control flow diagram, can be implemented by computer program instructions. These computer program instructions may be loaded onto a processing element, such as a computer, server, or other programmable apparatus, to produce a machine, such that the instructions which execute on the processing element create means for implementing the functions specified in the block(s) or step(s) of the control flow diagram. These computer program instructions may also be stored in a computer-readable memory that can direct the processing element to function in a particular manner, such that the instructions stored in the computer-readable memory produce an article of manufacture including instruction means which implement the function specified in the block(s) or step(s) of the control flow diagram. The computer program instructions may also be loaded onto the processing element to cause a series of operational steps to be performed on the processing element to produce a computer implemented process such that the instructions which execute on the processing element provide steps for implementing the functions specified in the block(s) or step(s) of the control flow diagram.

Accordingly, blocks or steps of the control flow diagram support combinations of means for performing the specified functions, combinations of steps for performing the specified functions, and program instruction means for performing the specified functions. It will also be understood that each block or step of the control flow diagram, and combinations of blocks or steps in the control flow diagram, can be implemented by special purpose hardware-based computer systems which perform the specified functions or steps, or combinations of special purpose hardware and computer instructions.

Therefore, the present invention provides a method, system, and computer-readable medium that are capable of dynamically identifying conveyances proximate to travel anchors or along travel route corridors. The conveyances present any number of travel options to the consumer such that travel routes may be recommended to the traveler, or the traveler may customize the itinerary based on various conveyances, travel preferences, amenities, etc. Trip value tables may also be generated by the method, system, and computer readable medium of the present invention that list historical booking information that provides a price value index to the consumer, which may be used by the consumer to pre-price their travel choices, as well as to provide historical comparisons with other seasons, years, or options. The trip value tables may be conveniently displayed to the traveler so that the traveler may readily determine whether to book a reservation.

As a result, suppliers of the conveyances and service providers may achieve merchandising revenue through several revenue streams. For instance, sellers and suppliers may be willing to purchase advertising through screen positioning, option selections, and pop-up advertisements. Revenue may also be generated by selling additional conveyance options between anchors, as well as selling merchant and published hotels at anchors and along the route corridors along with various travel options or preferences. These options can be enabled through subscriptions, bidding or targeted conveyances and/or routes as agreed by a supplier and service provider. Also, providing the traveler with more than one low priced conveyance will most likely result in increased revenue from a higher session-to-book conversion.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for generating travel options along a route comprising the steps of:
identifying a plurality of conveyances with each having associated booking information in response to a request for travel;
generating a trip value table in response to the request, wherein the trip value table includes booking information and historical information for comparable conveyances; and
outputting the conveyances, associated booking information, and trip value table.

2. The method according to claim 1, wherein a conveyance comprises a bus trip, train trip, cruise, automobile rental, flight, and hotel stay.

3. The method according to claim 1, wherein generating comprises generating the plurality of conveyances and associated booking information in real-time.

4. The method according to claim 1, further comprising receiving the request for travel comprising at least one of price, origin, destination, dates, number of travelers, points of interest, travel preferences, preferred route, and amenities.

5. The method according to claim 1, wherein generating the plurality of conveyances comprises generating the conveyances proximate to an anchor.

6. The method according to claim 1, wherein generating the plurality of conveyances comprises generating the conveyances along a corridor.

7. The method according to claim 1, wherein generating the plurality of conveyances comprises generating a sequence of conveyances along a proposed travel route.

8. The method according to claim 7, wherein the sequence of conveyances comprises at least two different types of conveyances.

9. The method according to claim 1, wherein generating the plurality of conveyances comprises generating a plurality of proposed travel routes.

10. The method according to claim 1, further comprising identifying an upsell opportunity based on the plurality of conveyances, associated booking information, and trip value table, wherein the upsell increases a price of at least one conveyance based on comparable prices for other conveyances.

11. The method according to claim 1, further comprising displaying the plurality of conveyances, associated booking information, and trip value table on an interactive map.

12. The method according to claim 1, wherein the historical information comprises a list of lowest prices for the request for travel.

13. The method according to claim 1, wherein the booking information of the trip value table comprises at least one of price, type of conveyance, vendor, year, dates, and length of stay for the request for travel.

14. The method according to claim 1, further comprising periodically updating the trip value table.

15. The method according to claim 1, wherein the associated booking information comprises at least one of price, availability, vendor, origin, destination, and dates of the request for travel.

16. A computer-readable medium containing instructions for causing a computing device to perform the steps of:
identifying a plurality of conveyances with each having associated booking information in response to a request for travel;
generating a trip value table in response to the request, wherein the trip value table includes booking information and historical information for comparable conveyances; and
outputting the conveyances, associated booking information, and trip value table.

17. The computer readable medium according to claim 16, wherein a conveyance comprises a bus trip, train trip, cruise, automobile rental, flight, and hotel stay.

18. The computer readable medium according to claim 16, wherein generating comprises generating the plurality of conveyances and associated booking information in real-time.

19. The computer readable medium according to claim 16, further comprising receiving the request for travel comprising at least one of price, origin, destination, dates, number of travelers, points of interest, travel preferences, preferred route, and amenities.

20. The computer readable medium according to claim 16, wherein generating the plurality of conveyances comprises generating the conveyances proximate to an anchor.

21. The computer readable medium according to claim 16, wherein generating the plurality of conveyances comprises generating the conveyances along a corridor.

22. The computer readable medium according to claim 16, wherein generating the plurality of conveyances comprises generating a sequence of conveyances along a proposed travel route.

23. The computer readable medium according to claim 22, wherein the sequence of conveyances comprises at least two different types of conveyances.

24. The computer readable medium according to claim 16, wherein generating the plurality of conveyances comprises generating a plurality of proposed travel routes.

25. The computer readable medium according to claim 16, further comprising identifying an upsell opportunity based on the plurality of conveyances, associated booking information, and trip value table, wherein the upsell increases a price of at least one conveyance based on comparable prices for other conveyances.

26. The computer readable medium according to claim 16, further comprising displaying the plurality of conveyances, associated booking information, and trip value table on an interactive map.

27. The computer readable medium according to claim 16, wherein the booking information of the trip value table comprises at least one of price, type of conveyance, vendor, year, dates, and length of stay for the request for travel.

28. The computer readable medium according to claim 27, wherein the historical information comprises a list of lowest prices for the request for travel.

29. The computer readable medium according to claim 16, further comprising periodically updating the trip value table.

30. The computer readable medium according to claim 16, wherein the associated booking information comprises at least one of price, availability, vendor, origin, destination, and dates of the request for travel.

31. A system for generating travel options along a route comprising:
at least one processing element for identifying a plurality of conveyances with each having associated booking information in response to a user request, generating a trip value table having booking information and historical information for comparable conveyances in response to the request, and outputting the conveyances, associated booking information, and trip value table.

32. The system according to claim 31, further comprising a client device for inputting the request for travel.

33. The system according to claim 32, wherein the processing element generates the conveyances proximate to an anchor.

34. The system according to claim 32, wherein the processing element generates the conveyances along a corridor.

34. The system according to claim 31, wherein the processing element generates a sequence of conveyances along a proposed travel route.

35. The system according to claim 31, wherein the processing element generates a plurality of proposed travel routes.

36. The system according to claim 31, wherein the processing element identifies an upsell opportunity based on the plurality of conveyances, associated booking information, and trip value table.

37. The system according to claim 31, wherein the processing element displays the plurality of conveyances, associated booking information, and trip value table on an interactive map.

38. The system according to claim 31, wherein the processing element periodically updates the trip value table.

39. The system according to claim 31, further comprising a storage element for storing the historical information.
